(19) United States
(12) Patent Application Publication
(10) Pub. No.: US 2011/0260981 A1
(43) Pub. Date: Oct. 27, 2011

(54) HAND-HELD WIRELESS COMPUTER KEYBOARD

(76) Inventors: CHIN-HO O CHEN, Banciao City (TW); PO-WEN HUANG, Shenkeng Township (TW); FEI CHUN KO, Yongkang City (TW)

(21) Appl. No.: 12/765,872

(22) Filed: Apr. 23, 2010

(51) Int. Cl. G06F 3/02

(52) U.S. Cl. 345/169

(57) ABSTRACT

The computer keyboard is compact for easy holding and operating by hands. In a front portion, a wireless signal transmitter is housed. Two lateral sides are curved downward to form two hand-held portions for convenient hand holding. On the top surface of the computer keyboard where the two thumbs could easily reach, an ordinary computer key pad is laid out. In the key pad, a special key is provided, which could switch the definitions of some keys, and allow the configuration of key combinations to perform a specific control function. As such, the computer keyboard is able to use a minimum number of keys in the key pad. On the bottom surface where the index or middle fingers could easily touch, a touch pad is provided for controlling the computer cursor.

### (a) TECHNICAL FIELD OF THE INVENTION

The present invention generally relates to computer input devices, and more particular to a wireless keyboard equipped with a touch pad which is compact enough for holding and operating by both hands.

### (b) DESCRIPTION OF THE PRIOR ART

Keyboard is the most basic and most important input device to a computer as a user could instruct the computer to conduct the desired digital data processing by issuing commands to the computer. In addition to the keyboard, pointing devices such as mouse and touch pad for moving and clicking cursors to speed up operations have also become computers' standard input devices.

As computers have become an integral part of people's life, a lot of users do not like to be confined to a desk when using the computer. A notebook computer is certainly more portable but the notebook computer's small screen cannot provide the desired entertainment effect. In addition, a user even without poor eyesight usually has to be very close to the screen so as to operate the notebook computer, putting the user under the influence of the electromagnetic wave and radiation of the computer and screen.

Therefore, a household user would naturally expect that he or she could be relaxed on a sofa or even bed and operate the computer remotely like operating a TV. As such, the user is immune from the potential hazards of the electromagnetic radiation. Even though wireless keyboards and mice are already commercially available, they are still too bulky to handle single-handedly like a TV remote controller. If the keyboard is shrunk to a small keypad like the one on a mobile phone, it would be too difficult to use. Therefore, there is still a large gap between user's expectation and the current state of art of computer input devices.

### SUMMARY OF THE INVENTION

Therefore, a major objective of the present invention is to provide a novel computer keyboard which is compact for easy holding and operating by hands at the same time. In a front portion of the computer keyboard, a wireless signal transmitter is housed whose radio signal is capable of penetrating the casing of the computer keyboard, which is shaped as a dog biscuit with two longer lateral sides and a shorter middle section. The two lateral sides are curved downward to form two hand-held portions for convenient hand holding. On the top surface of the computer keyboard where the two thumbs could easily reach, an ordinary computer key pad is laid out. In the key pad, a special key is provided, which could switch the definitions of the keys, and allow the configuration of key combinations to perform a specific control function. As such, the computer keyboard is able to use a minimum number of keys in the key pad. On the bottom surface of the computer keyboard where the index or middle fingers could easily touch, a touch pad is provided for controlling the computer cursor. When the computer keyboard is held by both hands, as such, a user could operate the computer cursor without flipping the computer keyboard in a single-contact or multiple-contact manner. Within the touch pad, a fast scrolling area simulating a computer mouse is provided. According to another objective of the present invention, the computer keyboard has a power circuit installed with a USB port exposed on the casing of the computer keyboard for connection with a computer for drawing electricity to charge a rechargeable battery of the computer keyboard.

According to yet another objective of the present invention, the hand-held portions of the computer keyboard are configured with curved indentations to facilitate hand holding and the extension of fingers.

According to still another objective of the present invention, the key pad's keys could be thin-film switch keys whose key surfaces could be electronic transparent films. As such, under dimly lit environment, the keys could be lit and a user could clearly see the markings on the key surfaces.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a top-view diagram showing a wireless hand-held computer keyboard according to an embodiment of the present invention.

FIG. 2 is a perspective diagram showing the wireless hand-held computer keyboard of FIG. 1.

FIG. 3 is a perspective diagram showing the bottom of the wireless hand-held computer keyboard of FIG. 1.

FIG. 4 is a side-view diagram showing the wireless hand-held keyboard of FIG. 1.

FIG. 5 is a perspective diagram showing an operation scenario of the wireless hand-held computer keyboard of FIG. 1.

FIG. 6 is a perspective diagram showing another operation scenario of the wireless hand-held computer keyboard of FIG. 1.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

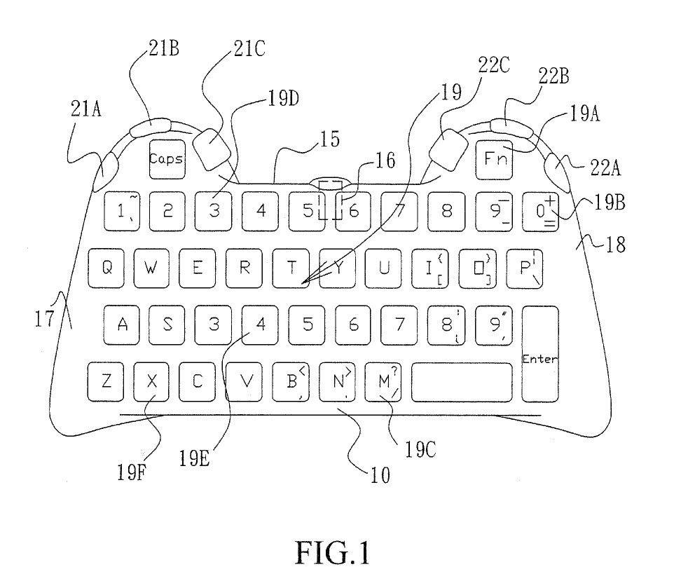

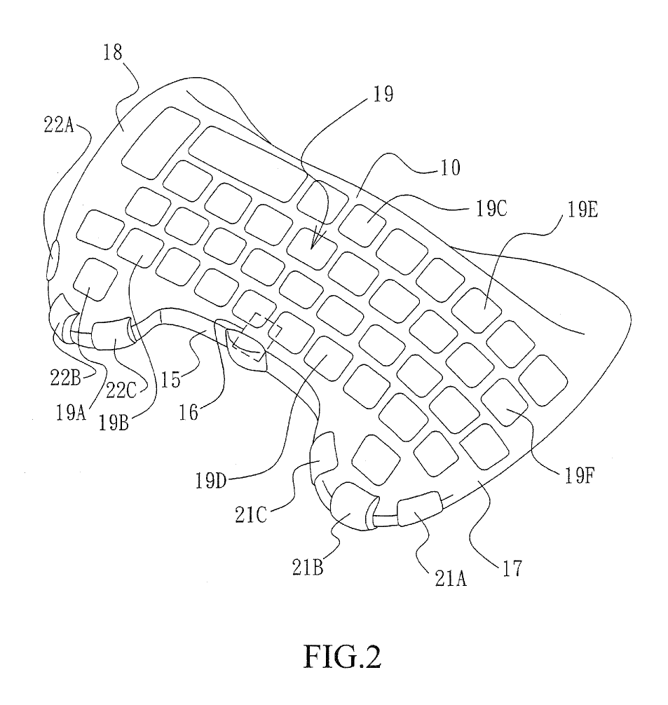

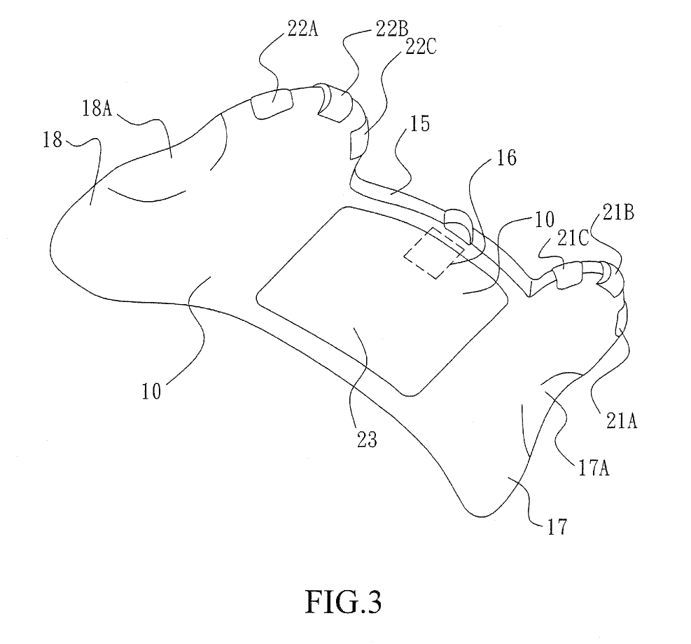

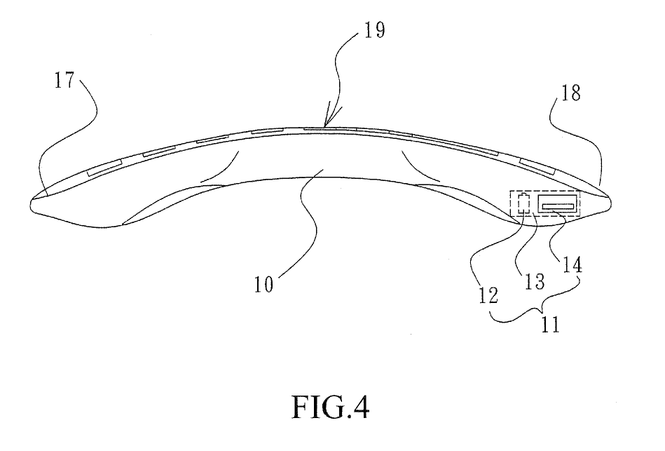

FIG. 1 is a top-view diagram showing a wireless hand-held computer keyboard 10 according to an embodiment of the present invention. FIG. 2 is a perspective diagram showing the computer keyboard 10. FIG. 3 is another perspective diagram showing the bottom of the computer keyboard 10. FIG. 4 is a side-view diagram showing the computer keyboard 10. Inside the computer keyboard 10, a power circuit 11 is installed, which contains a rechargeable battery 12 and a charging control circuit 13 having a USB port 14 exposed on the casing of the computer keyboard 10. The USB port 14 is for connection with a corresponding USB port on a computer for drawing electricity to charge the rechargeable battery 12.

Inside a front middle portion 15 of the computer keyboard 10's casing, a wireless signal transmitter 16 is installed, whose radio signal is able to penetrate the casing. There are various wireless technologies such as Bluetooth, infrared, and so on, that are readily applicable to the wireless signal transmitter 16. The computer keyboard 10 is shaped as a dog biscuit whose two lateral sides are longer than its middle portion and the two lateral sides are curved downward to form hand-held portions 17 and 18. The hand-held portions 17 and 18 allow the computer keyboard 10 to rest reliably on a flat surface and to be held by the palms of both hands. On the top surface of the computer keyboard 10 where the two thumbs could easily reach, an ordinary computer key pad 19 is laid out. In the key pad 19, a special key 19A is provided, which could switch the definitions of the composite keys 19B and 19C, and allow the configuration of key combinations to perform a specific control function. As such, the computer keyboard 10 is able to use a minimum number of keys in the key pad 19 to cover the various functions of a normal computer keyboard and the computer keyboard 10 therefore could be downsized. On the bottom surface of the computer keyboard 10 where the index or middle fingers could easily touch, a touch pad 20 is provided for controlling the computer cursor. When the computer keyboard 10 is held by both hands, as such, a user could operate the computer cursor without flipping the computer keyboard 10 in a single-contact or multiple-contact manner. On the bottom surface the hand-held portions 17 and 18, curved indentations 17A and 18A could be further provided in the middle of an outer edge of the hand-held portions 17 and 18 facilitate hand holding and the extension of fingers. Within the touch pad 20, a fast scrolling area 23 simulating a computer mouse is provided. On the front surfaces of the hand-held portions 17 and 18, function keys 21A, 22A, 21B, 22B, 21C, 22C are configured whose definitions are user-definable. The key pad 19's keys could be thin-film switch keys whose key surfaces 19D, 19E, 19F could be electronic transparent films. As such, under dimly lit environment, the keys could be lit and a user could clearly see the markings on the key surfaces 19E, 19E, 19F. As the related technology is quite mature, it is also possible to adjust the brightness of the key surfaces 19E, 19E, 19F by some specific key in the key pad 19.

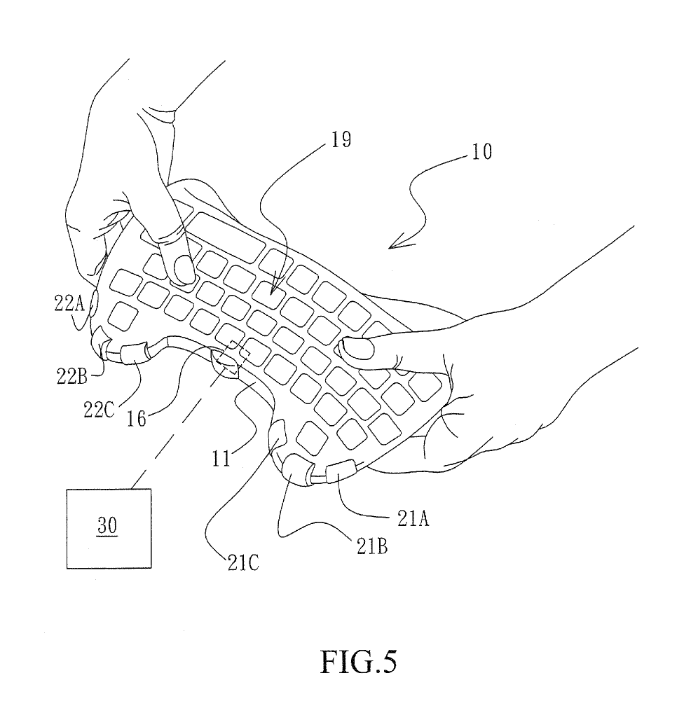

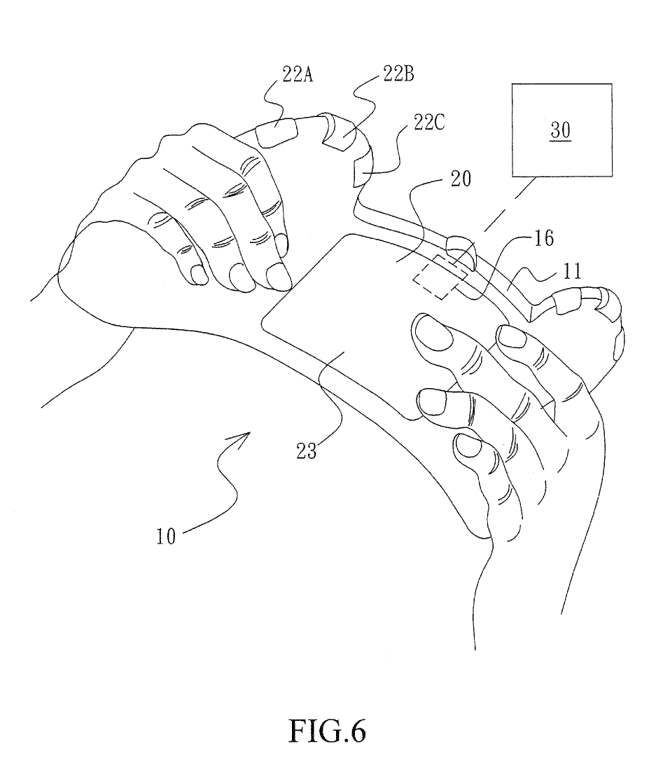

FIG. 5 is a perspective diagram showing an operation scenario of the computer keyboard 10. As illustrated, when the computer keyboard 10 is held by both hands, a user could his or her two thumbs to operate all keys of the key pad 19. FIG. 6 is a perspective diagram showing another operation scenario of the computer keyboard 10. As illustrated, the user is able to operate the touch pad 20 to control computer cursor and his or her index or middle fingers could reach the entire surface of the touch pad 20, including the fast scrolling area 23. In the mean time, his or her fingers could also be extended to reach the function keys 21A, 22A, 21B, 22B, 21C, 22C. As such, the computer keyboard 10, together with its wireless remote connectivity to a computer, is very suitable for hand-held operating at a distance from the computer. The USB port 14, in addition to drawing electricity from a source, allows the computer keyboard 10 to be used in a wired manner by cabling the computer keyboard 10 to the computer via a USB cable and the USB port 14.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A wireless hand-held computer keyboard, comprising:
a casing having a shape whose two lateral sides are longer than a middle section of said casing, said two lateral sides being curved downward to form two hand-held portions;
a power circuit inside said casing;
a wireless signal transmitter inside a front portion of said casing, said wireless signal transmitter capable of sending radio signals through said casing;
a key pad having a plurality of keys on a top surface of said casing where each said key is reachable by one of a user's thumb when said computer keyboard is held by said user by both hands; and
a touch pad capable of simulating a computer mouse on a bottom surface of said casing which is reachable by one of a user's index or middle finger when said computer keyboard is held by said user by both hands.

2. The wireless hand-held computer keyboard according to claim 1, wherein said power circuit contains a rechargeable battery and a charging control circuit; said charging control circuit has an USB port exposed on the casing of said computer keyboard for connection with a computer for drawing electricity to charge said rechargeable battery.

3. The wireless hand-held computer keyboard according to claim 1, wherein, on a bottom surface of each said hand-held portion, a curved indentation is provided in the middle of an outer edge of said hand-held portion.

4. The wireless hand-held computer keyboard according to claim 1, wherein, along a front surface of each said hand-held portions, a plurality of function keys are provided.

5. The wireless hand-held computer keyboard according to claim 1, wherein each said key of said keyboard is a thin-film switch key whose key surface is an electronic transparent film; and, when said keys are turned on, markings on said keys are clearly visible.

6. The wireless hand-held computer keyboard according to claim 1, wherein said touch pad is operable without flipping said computer keyboard.

7. The wireless hand-held computer keyboard according to claim 1, wherein said touch pad has a fast scrolling area simulating a computer mouse.

8. The wireless hand-held computer keyboard according to claim 1, wherein said touch pad is operable in a multi-touch manner.
